(19) United States
(12) Patent Application Publication
(10) Pub. No.: US 2026/0233410 A1
(43) Pub. Date: Aug. 13, 2026

(54) ELECTRONIC DEVICE

(71) Applicant: Advanced Semiconductor Engineering, Inc., Kaohsiung (TW)

(72) Inventor: Yung-Li LU, Kaohsiung (TW)

(73) Assignee: Advanced Semiconductor Engineering, Inc., Kaohsiung (TW)

(21) Appl. No.: 19/050,099

(22) Filed: Feb. 10, 2025

(51) Int. Cl. B25J 13/08; B25J 15/10; G01L 5/167

(52) U.S. Cl. CPC B25J 13/082; B25J 13/087; B25J 15/10; G01L 5/167

(57) ABSTRACT

The present disclosure relates to an electronic device for detecting a robotic motion. The electronic device includes a 6-axis movable module and a plurality of sensing modules. The plurality of sensing modules are mounted on and protrude from an outer surface of the 6-axis movable module for detecting an amount of a rotation along at least one axis.

### BACKGROUND

### 1. Technical Field

The present disclosure generally relates to an electronic device for detecting a robotic motion, and more particularly to an electronic device including a robotic arm and a sensing module mounted on the robotic arm.

### 2. Description of the Related Art

Robotics is experiencing rapid development, with humanoid robots being particularly popular. The present robots primarily rely on computer control to perform specific actions. However, with technology evolving, robots need to possess a high level of perception and cognitive abilities to operate and interact within complex environments. For example, a robot is required to be able to sense how much force to apply when picking up an object (such as an egg) to avoid using too much force, which could damage the object, or too little force, which could result in failing to pick it up successfully. Therefore, an improved electronic device for robotic arm with sensors is called for.

### SUMMARY

In some embodiments, an electronic device for detecting a robotic motion includes a 6-axis movable module and a plurality of sensing modules. The plurality of sensing modules are mounted on and protrude from an outer surface of the 6-axis movable module for detecting an amount of a rotation along at least one axis.

In some embodiments, an electronic device for detecting a robotic motion includes a robotic arm and a sensing module. The sensing module protrudes from an outer surface of the robotic arm and includes an encapsulant configured to transmit a force applied on the sensing module.

In some embodiments, a method for controlling a robot includes: identifying an object to be grabbed by the robot; detecting, by a first sensing module mounted on a robotic arm of the robot, a first signal when the robotic arm holds the object; detecting, by a second sensing module mounted on a joint of the robotic arm of the robot, a second signal when the robotic arm holds the object; and controlling the robotic arm in response to the first signal and the second signal.

### BRIEF DESCRIPTION OF THE DRAWINGS

Aspects of the present disclosure are readily understood from the following detailed description when read with the accompanying figures. It should be noted that various features may not be drawn to scale. The dimensions of the various features may be arbitrarily increased or reduced for clarity of discussion.

FIG. 1 is a schematic diagram of a system for controlling a robotic arm, in accordance with some embodiments of the present disclosure.

FIG. 2 is a cross-section of an electronic device, in accordance with some embodiments of the present disclosure.

FIG. 3A is a schematic diagram of an electronic device, in accordance with some embodiments of the present disclosure.

FIG. 3B is a schematic diagram of an electronic device, in accordance with some embodiments of the present disclosure.

FIG. 4A is a perspective view showing the utilization of robotic arms, in accordance with some embodiments of the present disclosure.

FIG. 4B is a schematic diagram of an electronic device, in accordance with some embodiments of the present disclosure.

FIG. 5A is a perspective view showing the utilization of robotic arms, in accordance with some embodiments of the present disclosure.

FIG. 5B is a schematic diagram of an electronic device, in accordance with some embodiments of the present disclosure.

FIG. 6 is a schematic diagram of a system for controlling a robot, in accordance with some embodiments of the present disclosure.

FIG. 7 is a flowchart showing a method for controlling a robot, in accordance with some embodiments.

Common reference numerals are used throughout the drawings and the detailed description to indicate the same or similar elements. The present disclosure will be more apparent from the following detailed description taken in conjunction with the accompanying drawings.

### DETAILED DESCRIPTION

The following disclosure provides different embodiments, or examples, for implementing different features of the provided subject matter. Specific examples of components and embodiments are recited herein. These are, of course, merely examples and are not intended to be limiting. In the present disclosure, reference to the formation of a first feature over or on a second feature in the description that follows may include embodiments in which the first and second features are formed in direct contact, and may also include embodiments in which additional features may be formed between the first and second features, such that the first and second features may not be in direct contact. The present disclosure may repeat reference numerals and/or letters in the various examples. This repetition is for simplicity and clarity and does not in itself dictate a relationship between the various embodiments and/or configurations discussed.

Embodiments of the present disclosure are discussed in detail as follows. It should be appreciated, however, that the present disclosure provides many applicable concepts that can be embodied in a wide variety of specific contexts. The specific embodiments discussed are merely illustrative and do not limit the scope of the disclosure.

Embodiments of the present disclosure discuss an electronic device including a robotic arm and multiple sensing modules mounted on the external of the robotic arm. The sensing modules on the robotic arm can act as the sensory nerves in the human skin. The sensing modules may be deployed to encompass the external surface of the robotic arm, thereby enabling the detection of forces encountered upon contact with objects or resulting from the bending of the robotic arm due to the holding or grasping of objects. Subsequently, the robotic arm is capable of executing actions in response to the forces thus detected.

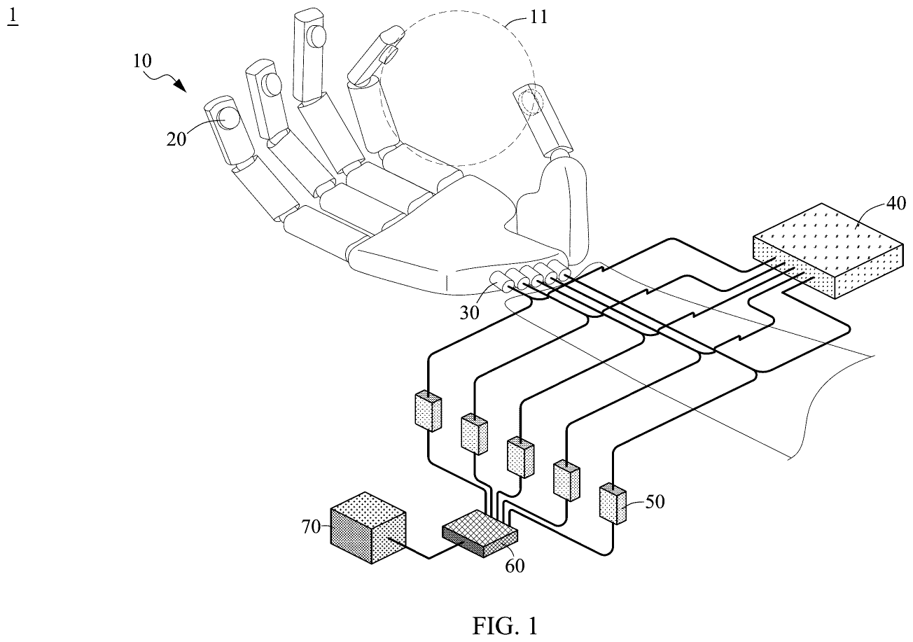

FIG. 1 is a schematic diagram of a system 1 for controlling a robotic arm, in accordance with some embodiments of the present disclosure. The system 1 can include a 6-axis motion module 10, one or more sensing modules 20, signal processing circuits 30, 40, and 50, a selector 60, and a processor 70.

In some embodiments, the system 1 may be performed by an electronic device. For example, the electronic device may be a robot, particularly a humanoid robot. In some embodiments, the 6-axis motion module 10 (or called 6-axis movable module) may include a robotic arm. For clarity, FIG. 1 merely shows a part of the robotic arm, in particular the palm and fingers. In some embodiments, the 6-axis motion module 10 may be configured to hold or grab an object 11.

Referring to FIG. 1, the sensing modules 20 may be mounted on and protruding from an outer surface of the 6-axis motion module 10. The sensing modules 20 may be located at the arm portion or the joint portion of the 6-axis motion module 10. In some embodiments, the sensing modules 20 may be arranged in an array on the outer surface of the 6-axis motion module 10. In some embodiments, the sensing modules 20 may be located at an end of the 6-axis motion module 10. For example, the sensing modules 20 may be located at the fingers, palm, wrist, arm, and elbow of the 6-axis motion module 10.

The sensing modules 20 may be configured to detect an amount of a rotation along at least one axis of the 6-axis motion module 10. In some embodiments, the sensing modules 20 may be configured to detect a force applied to the sensing modules 20 (or the 6-axis motion module 10). For example, the sensing modules 20 may be configured to detect the force applied to the sensing modules 20 upon contact with object 11. The sensing modules 20 may include a pressure sensor. In some embodiments, the sensing modules 20 may be configured to continuously detect a force applied to the sensing modules 20 (or the 6-axis motion module 10).

The signal processing circuit 30 may be connected between the sensing modules 20 and the processor 70. The signal processing circuit 30 may be electrically connected to the sensing modules 20 to receive signals associated with the force applied to the sensing modules 20. In some embodiments, the signal processing circuit 30 may be configured to denoise, amplify, or rectify the signal detected by the sensing modules 20. For example, the signal processing circuit 30 may include a filter or an amplifier. In some embodiments, the signal processing circuit 30 may be separated from the 6-axis motion module 10. In other embodiments, the signal processing circuit 30 may be embedded in the 6-axis motion module 10.

The signal processing circuit 40 may be connected between the sensing modules 20 and the processor 70. The signal processing circuit 40 may be electrically connected to the signal processing circuit 30 to receive signals detected by the sensing modules 20. In some embodiments, the signal processing circuit 40 may be configured to select and/or decode the signals received from the sensing modules 20. That is, the signal processing circuit 40 may be connected to the array of the sensing modules 20. For example, the signal processing circuit 40 may include a column or row decoder. In some embodiments, the signal processing circuit 40 may be separated from the 6-axis motion module 10. In other embodiments, the signal processing circuit 40 may be embedded in the 6-axis motion module 10.

The signal processing circuit 50 may be connected between the sensing modules 20 and the processor 70. The signal processing circuit 50 may be electrically connected to the signal processing circuit 40 to receive signals detected by the sensing modules 20. In some embodiments, the signal processing circuit 50 may be configured to convert the format of the signals received from the sensing modules 20. For example, the signal processing circuit 50 may include an analog-to-digital (A/D) convertor. In some embodiments, the signal processing circuit 50 may be separated from the 6-axis motion module 10. In other embodiments, the signal processing circuit 50 may be embedded in the 6-axis motion module 10.

The selector 60 may be connected between the sensing modules 20 and the processor 70. The selector 60 may be electrically connected to the signal processing circuits 50 to receive signals detected by the sensing modules 20. The selector 60 may be connected to multiple signal processing circuits 50. In some embodiments, the selector 60 may be configured to select one or more of the signals obtained by the sensing modules 20. For example, the selector 60 may include a multiplexer (MUX). In some embodiments, the selector 60 may be separated from the 6-axis motion module 10. In other embodiments, the selector 60 may be embedded in the 6-axis motion module 10.

The processor 70 may be electrically connected to the selector 60 to receive signals detected by the sensing modules 20 and being processed by the signal processing circuits 30, 40, and 50. That is, the processor 70 may be connected to the selector 60 to receive signals associated with the force applied to the sensing modules 20. The processor 70 may be electrically connected to the 6-axis motion module 10 and the sensing modules 20. In some embodiments, the processor 70 may be configured to control the 6-axis motion module 10 based on signals associated with the force applied to the sensing modules 20. For example, the processor 70 may be configured to control the 6-axis motion module 10 to grab the object 11 in response to signals associated with the force received from the sensing modules 20. In some embodiments, the processor 70 may be configured to control the 6-axis motion module 10 to bend or rotate in response to signals associated with the force received from the sensing modules 20. In some embodiments, the processor 70 may include an artificial intelligent (AI) chip. With advanced computing ability, the robot can perform more precise actions, such as holding objects, grabbing eggs, shaking hands, pushing buttons, or massaging.

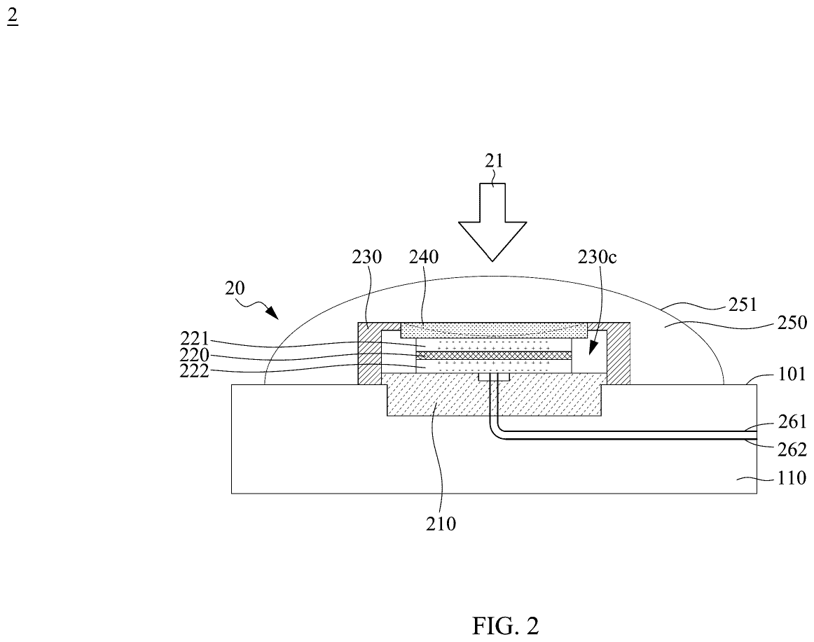

FIG. 2 is a cross-section of an electronic device 2, in accordance with some embodiments of the present disclosure. The electronic device 2 may include a protection layer 110 and a sensing module 20 disposed on the protection layer 110.

The protection layer 110 may be disposed on the outside of the 6-axis motion module (or robotic arm) 10 of FIG. 1 (omitted in FIG. 2). The protection layer 110 may cover the 6-axis motion module 10 to protect the circuits and elements therein. The protection layer 110 may have an upper surface 101, which may be the outer surface of the 6-axis motion module 10. The protection layer 110 may include a liquid silicone rubber (LSR).

The sensing module 20 may be attached to and partially embedded in the protection layer 110. Referring to FIG. 2, the sensing module 20 may include a substrate 210, a piezoelectric element 220, a frame 230, a film 240, an encapsulant 250, and electrical connections 261 and 262.

In some embodiments, the substrate 210 may be a carrier to support other elements of the sensing module 20. The substrate 210 may be disposed on the protection layer 110. The substrate 210 may have a first portion embedded in the protection layer 110, and a second portion protruding from the upper surface 101 of the protection layer 110.

The frame 230 may be disposed on the protection layer 110. In some embodiments, the frame 230 may be disposed on and in contact with the upper surface 101 of the protection layer 110. The frame 230 may be laterally connected to the substrate 210. The frame 230 may surround the piezoelectric element 220. The frame 230 may define a cavity 230c for accommodating the piezoelectric element 220. In some embodiments, the piezoelectric element 220 may be disposed in the center of the cavity 230c. In some embodiments, the frame 230 may be a hollow structure, which can take the form of a cylinder, rectangle, or other shapes. In some embodiments, the frame 230 may include a sidewall vertically extending from the upper surface 101 and a top plate connected to the sidewall. The top plate of the frame 230 may have an opening to expose the piezoelectric element 220, wherein the opening is greater than the piezoelectric element 220.

The piezoelectric element 220 may be disposed on the substrate 210. In some embodiments, the substrate 210 may be disposed between the piezoelectric element 220 and the protection layer 110. The piezoelectric element 220 may laterally overlap the sidewall of the frame 230. The piezoelectric element 220 may have a first electrode 221 and a second electrode 222 disposed on opposite sides. The first electrode 221 may contact the film 240. The second electrode 222 may be disposed on and in contact with the protection layer 110.

The film 240 may cover the cavity 230c of the frame 230. The film 240 may be laterally connected to the frame 230. The film 240 may be flexible. That is, upon the application of force, the film 240 may deform and recede toward the piezoelectric element 220. The film 240 may be configured to transmit a force 21 applied to the sensing module 20 to the piezoelectric element 220. In some embodiments, the film 240 may be a metal foil film. In some embodiments, the film 240 may include a conductive material. For example, the conductive material include, but are not limited to, metals, such as aluminum, iron, copper, stainless steel, and the like, alloys.

The encapsulant 250 may be disposed on the protection layer 110. The encapsulant 250 may cover the substrate 210, the piezoelectric element 220, the frame 230 and the film 240. In some embodiments, the encapsulant 250 may be filled within the cavity 230c and encapsulate the piezoelectric element 220. The encapsulant 250 may encapsulate the piezoelectric element 220, the frame 230, and the film 240. The encapsulant 250 may have an upper surface 251. In some embodiments, the upper surface 251 may be curved. In some embodiments, the encapsulant 250 may be deformable. That is, the shape of the encapsulant 250 may depend on the force applied thereto. In some embodiments, the encapsulant 250 may be stretchable and/or compressible. Accordingly, the encapsulant 250 may be configured to transmit the force 21 applied on the sensing module 20. For example, the encapsulant 250 may include a conductive liquid silicone rubber (CLSR).

In some embodiments, the electrical connections 261 and 262 may be connected to the piezoelectric element 220. The electrical connections (or electrical paths) 261 and 262 may be embedded in the substrate 210 and the protection layer 110, and be electrically connected to the processor 70 of FIG. 1. In some embodiments, the electrical connections 261 and 262 may be accomplished through wires or other suitable electrical connectors.

In some embodiments, the piezoelectric element 220 may be configured to detect a force (or pressure) 21 applied to the sensing module 20 (or the 6-axis motion module 10 of FIG. 1). The sensing module 20 may be a pressure sensor. In some embodiments, the sensing module 20 may use a strain gauge (such as a piezoelectric element 220) as the pressure-sensitive element. Upon the application of force, the film 240 may deform and recede toward the piezoelectric element 220, causing a change in resistance, which is then converted into an electrical signal to detect and measure the applied force, pressure, or deformation. In some embodiments, the sensing module 20 may be arranged at a joint of the robotic arm, to determine a bending degree of the joint based on a deformation amount detected by the sensing module 20.

The present disclosure proposes an electronic device including a robotic arm equipped with several sensing modules 20 located on its exterior. These sensing modules 20 function similarly to sensory nerves in human skin. The sensing modules 20 can be placed around the outer surface of the robotic arm to detect forces that occur when the robotic arm comes into contact with objects while holding or grasping objects. In some cases, the sensing modules 20 can be placed around the joint of the robotic arm to detect deformation that occurs when the robotic arm bends while holding or lifting objects. As a result, the robotic arm can perform actions in response to the detected forces.

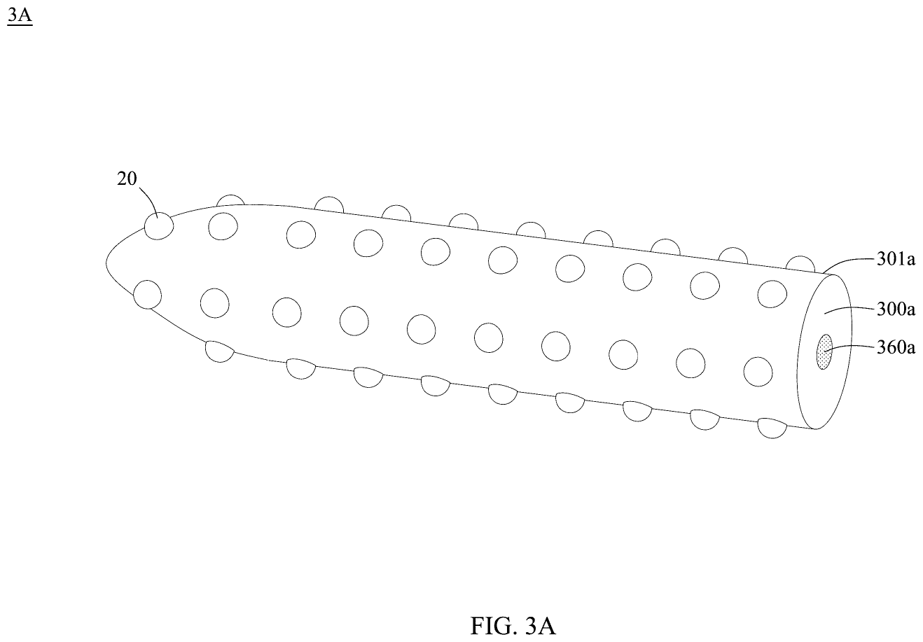

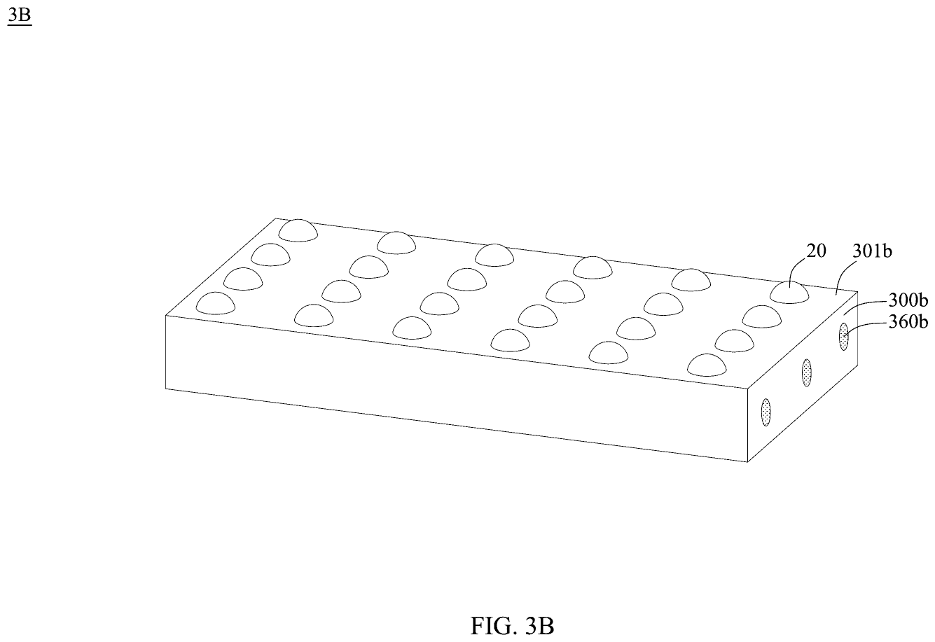

FIG. 3A is a schematic diagram of an electronic device 3A, in accordance with some embodiments of the present disclosure. The electronic device 3A includes a body 300a, an electrical connection 360a, and one or more sensing modules 20.

In some embodiments, the body 300a may embed the electrical connection 360a. The body 300a may further include structural elements, circuits, and other elements (not shown). The body 300a may be a part of the robotic arm. For example, the body 300a may be a finger of the robotic arm. The electrical connection 360a may be configured to connect the body 300a (and the sensing modules 20) to a processor (not shown), such that the processor can be configured to control the electronic device 3A based on the signals detected by the sensing modules 20.

In some embodiments, the sensing modules 20 may be arranged in an array on an outer surface 301a of the body 300a. The sensing modules 20 can be located at an end of the body 300a. For example, the sensing modules 20 can be located at the fingertip. The sensing modules 20 may be in contact with the object when it is grabbed by the robotic arm.

FIG. 3B is a schematic diagram of an electronic device 3B, in accordance with some embodiments of the present disclosure. The electronic device 3B includes a body 300b, one or more electrical connections 360b, and one or more sensing modules 20.

In some embodiments, the body 300b may embed the electrical connections 360b. The body 300b may further include structural elements, circuits, and other elements (not shown). The body 300b may be a part of the robotic arm. For example, the body 300b may be an exterior layer (such as a skin) of the robotic arm. That is, the body 300b may cover a structural element of the robotic arm and electrically connected to the controller to drive the structural element. The electrical connections 360b may be configured to connect the body 300b (and the sensing modules 20) to a processor (not shown), such that the processor can be configured to control the electronic device 3B based on the signals detected by the sensing modules 20.

In some embodiments, the sensing modules 20 may be arranged in an array on an outer surface 301b of the body 300b. The sensing modules 20 can be located at a plane or a joint of the robotic arm, such as the palm, wrist, arm, or elbow of the robotic arm. Those sensing modules 20 placed around the joint of the robotic arm may be free from contacting the object when the robotic arm is grabbing the object. In some embodiments, the sensing modules 20 placed around the joint of the robotic arm can be configured to detect deformation that occurs when the robotic arm bends while holding or lifting objects.

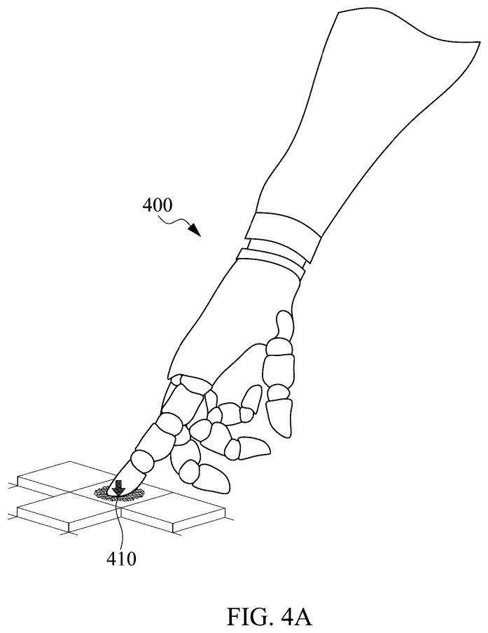

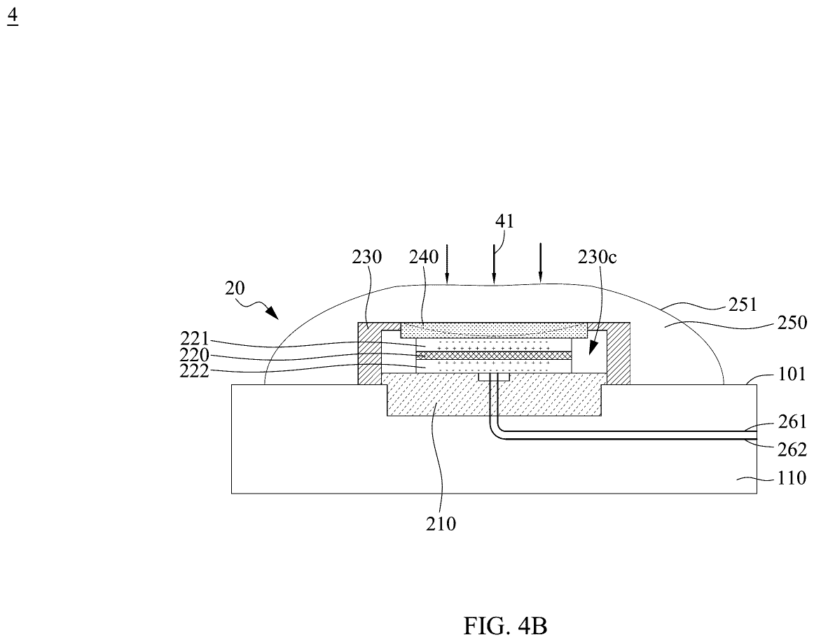

FIG. 4A is a perspective view showing the utilization of robotic arms, in accordance with some embodiments of the present disclosure. FIG. 4A shows a robotic arm 400 pushing a button. In some embodiments, the sensing modules 20 mounted on the robotic arm 400 may be covered by a protection layer, which is thin enough to accurately transmit the force. The sensing modules 20 (not shown) located at an end 410 (such as fingertip) of the robotic arm 400 can be configured to detect a pressure that occurs when the robotic arm 400 push the button, and then control the force applied to the button based on the signals detected by the sensing modules 20.

FIG. 4B is a schematic diagram of an electronic device 4, in accordance with some embodiments of the present disclosure. FIG. 4B illustrates a situation corresponding to the scenario depicted in FIG. 4A. The electronic device 4 is similar to the electronic device 2 of FIG. 2, but shows the sensing module 20 under force 41. In some embodiments, the force 41 may be directly applied to the sensing module 20. In some cases, the force 41 may be perpendicularly applied to the sensing module 20.

Upon force 41 being applied, the encapsulant 250 may be deformed and receded. That is, a portion of the upper surface 251 of the encapsulant 250 may become planar. The film 240 may correspondingly deform and recede toward the piezoelectric element 220, so that the piezoelectric element 220 may occur a change in resistance, which is then converted into an electrical signal to detect and measure the force 41. Subsequently, the signals detected by the sensing modules 20 may be transmitted to the processor 70 (not shown) via the electrical connections 261 and 262.

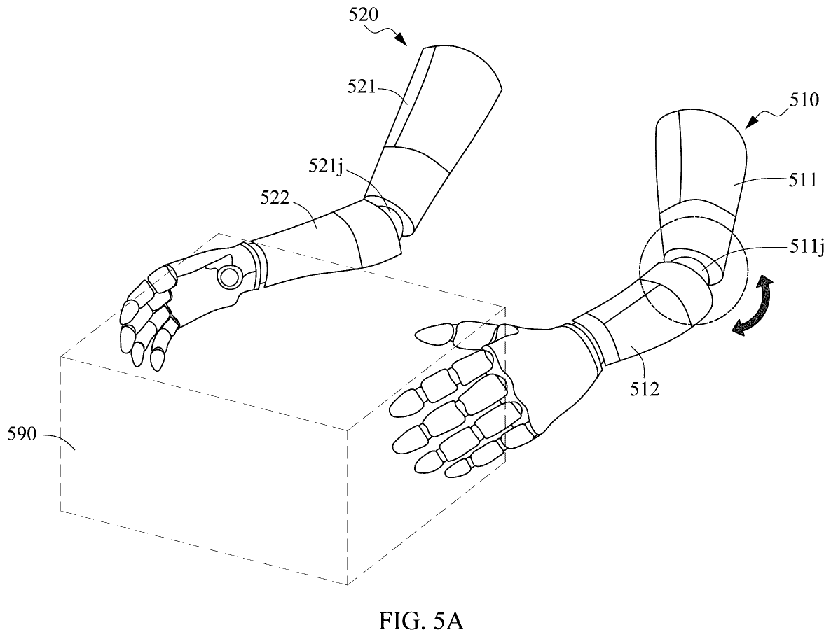

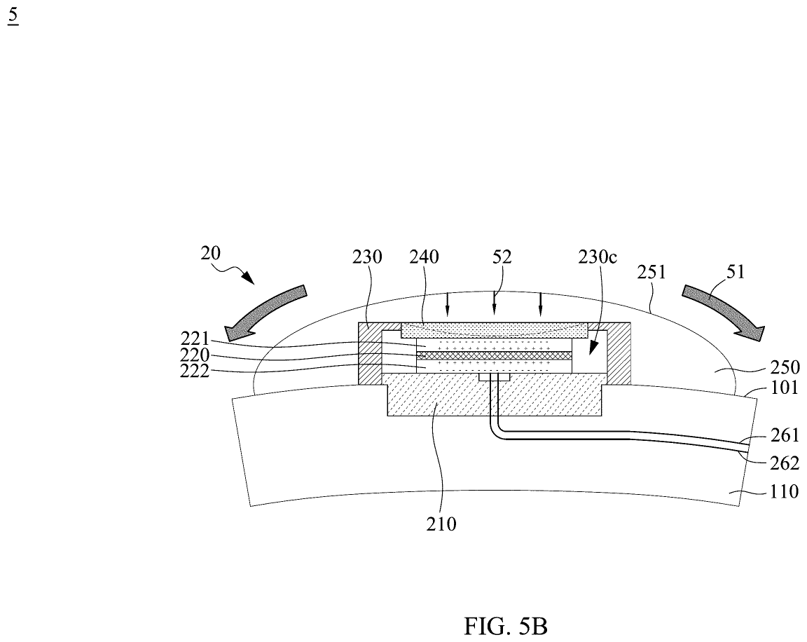

FIG. 5A is a perspective view showing the utilization of robotic arms, in accordance with some embodiments of the present disclosure. FIG. 5A shows two robotic arms 510 and 520 collaboratively holding an object 590. The robotic arm 510 includes a first arm 511, a second arm 512, and a joint 511j connecting the first arm 511 and the second arm 512. The robotic arm 520 includes a first arm 521, a second arm 522, and a joint 521j connecting the first arm 521 and the second arm 522. In some embodiments, several sensing modules 20 (not shown) can be mounted on the robotic arms 510 and 520 and be covered by a protection layer, which is thin enough to accurately transmit the force. The sensing modules 20 may be located, positioned, or distributed at the fingers, palm, wrist, arm, and elbow of the robotic arms 510 and 520. In some embodiments, the sensing modules 20 may be located at a joint 511j connecting. The sensing module 20 may be configured to detect a deformation caused by a bending of the joint 511j. The sensing modules 20 mounted on the robotic arm 520 may have the same arrangement.

The sensing modules 20 (not shown) can be configured to detect a pressure that occurs at the fingers or palm portion when the robotic arms 510 and 520 touch, contact, or hold the object 590, and detect a pressure that occurs at the wrist or elbow portion when the robotic arms 510 and 520 hold or lift the object 590. Then, the robotic arms 510 and 520 can be configured to control the force applied to the object 590 and the bending degree of the joints (wrist or elbow) based on the signals detected by the sensing modules 20 on multiple locations.

FIG. 5B is a schematic diagram of an electronic device 5, in accordance with some embodiments of the present disclosure. FIG. 5B illustrates a situation corresponding to the scenario depicted in FIG. 5A. The electronic device 5 is similar to the electronic device 2 of FIG. 2, but shows the sensing module 20 under bending force 51. In some embodiments, the electronic device 5 may be located the joint 511j of the robotic arm 510. The bending force 51 may be tension or compression caused by the movement or bending the joint 511j of the robotic arm 510.

Upon bending force 51 being applied, the encapsulant 250 may be deformed and receded along the direction 52. In some embodiments, the protection layer 110 may be bended under the bending force 51. That is, the middle portion of the encapsulant 250 may be thinner. The film 240 may correspondingly deform and recede toward the piezoelectric element 220, so that the piezoelectric element 220 may occur a change in resistance, which is then converted into an electrical signal to detect and measure the force 51. In some embodiments, the sensing module 20 may be arranged at the joint 511j of the robotic arm 510 to determine a bending degree of the joint 511j based on a deformation amount detected by the sensing module 20. Subsequently, the signals detected by the sensing modules 20 may be transmitted to the processor 70 (not shown) via the electrical connections 261 and 262.

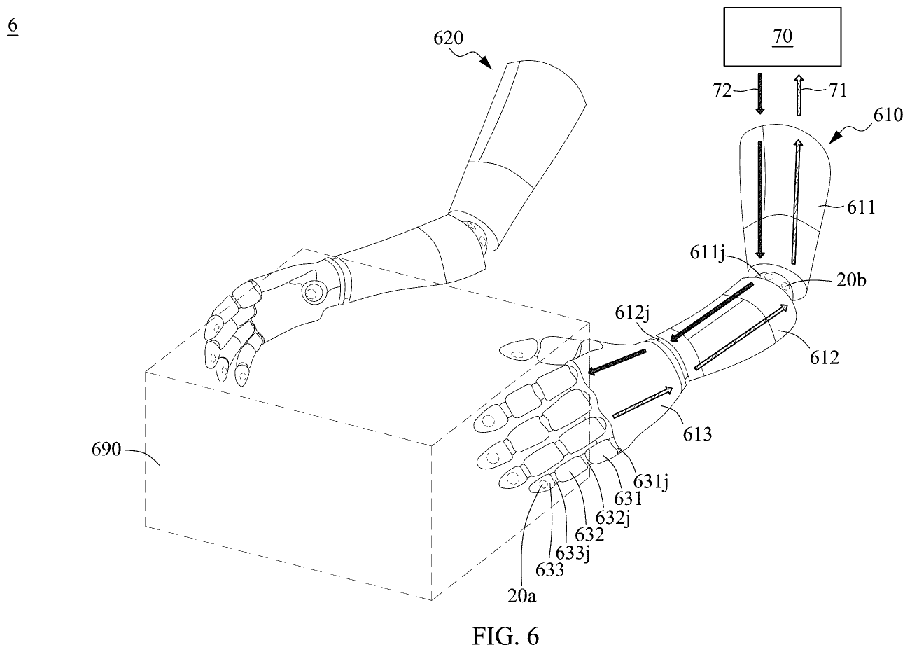

FIG. 6 is a schematic diagram of a system 6 for controlling a robot, in accordance with some embodiments of the present disclosure. FIG. 6 is similar to FIG. 5, but shows sensing modules 20a and 20b and the communication between the robotic arm the processor 70. The system 6 includes two robotic arms 610 and 620 and a processor 70. Other parts of the robot are omitted for clarity.

Referring to FIG .6, two robotic arms 610 and 620 can collaboratively hold an object 690. The robotic arm 610 may include two arms 611 and 612, joints 611j and 612j, palm 613, finger portions 631, 632, and 633, and joints 631j, 632j, and 633j. The joint 611j may connect the arms 611 and 312. The joint 612j may connect the arm 612 and the palm 613. The palm 613 may be connect to five fingers. Each finger may include finger portions 631, 632, and 633. The finger portion 633 may be the fingertip. The joint 633j may connect the finger portions 633 and 632. The joint 632j may connect the finger portions 632 and 631. The joint 631j may connect the finger portion 631 and the palm 613.

In some embodiments, the sensing modules 20a may be located, positioned, or distributed at the body part of the robotic arm 610, such as the finger portions 631, 632, 633, palm 613, arms 611 and 612 of the robotic arm 610. The sensing modules 20a can be configured to detect a pressure that occurs at the finger portions 631, 632, and 633 or the palm 613 when the robotic arm 610 touch, contact, or hold the object 690, and then the robotic arm 610 can be configured to control the force applied to the object 690 based on the signals detected by the sensing modules 20a.

The sensing modules 20b may be located, positioned, or distributed at the joints of the robotic arm 610, such as the joints 611j, 612j, 631j, 632j, and 633j. In some embodiments, the joint 611j may be referred as the elbow of the robotic arm 610. In some embodiments, the joint 612j may be referred as the wrist of the robotic arm 610. In some embodiments, the joints 631j, 632j, and 633j may be referred as the knuckles of the robotic arm 610. The sensing modules 20b may be configured to detect an amount of a rotation along at least one axis of the robotic arm 610. The sensing modules 20b can be configured to detect a pressure that occurs at the joint 611j or 612j when the robotic arm 610 hold or lift the object 690, and then the robotic arm 610 can be configured to control the bending degree and the related force of the joint 611j or 612j based on the signals detected by the sensing modules 20b. The sensing modules 20b may be configured to detect a deformation caused by a bending of the joints 611j, 612j, 631j, 632j, and 633j.

In some embodiments, a first number of the sensing modules 20a may be identical or different from a second number of the sensing modules 20b. The sensing modules 20a may be located at an arm 611 or 612 of the robotic arm 610, such that the sensing modules 20a can be configured to detect a force perpendicularly applied to the sensing modules 20a. In some embodiments, the sensing modules 20b may be located at the joint 611j connecting the arms 611 and 612 of the robotic arm 610. The sensing module 20b may be configured to detect a deformation caused by a bending of the joint 611j.

In some embodiments, the system 6 can include electrical paths 71 and 72 between the robotic arm 610 and the processor 70. The processor 70 may be electrically connected to the robotic arm 610. In some embodiments, the processor 70 may be located at the robotic arm 610. In other embodiments, the processor 70 may be located outside of the robotic arm 610. The processor 70 may be positioned at the head of the robot, when the robot is a humanoid robot. The processor 70 may include an AI chip to perform more precise operations.

The electrical path 71 may transmit the signals detected by the sensing modules 20a and 20b to the processor 70 through the robotic arm 610. The processor 70 may transmit commands to control the robotic arm 610 through the electrical path 72 in response to the detected signals. In some embodiments, the sensing modules 20a and 20b may be continuously detect the force applied thereto, such that the processor 70 can be configured to control the robot to perform precise operations.

The sensing modules 20a and 20b can be placed on the body parts and joints of the robotic arm 610. Specifically, the sensing modules 20a are designed to detect pressure at the fingers or palm when the robotic arm 610 touches, contacts, or grips the object 690. Meanwhile, the sensing modules 20b are intended to sense pressure at the wrist or elbow when the robotic arm 610 is holding or lifting the object 690. Consequently, the robotic arm 610 can be programmed to adjust the force applied to the object 690 and the degree of joint bending based on the signals received from the sensing modules 20a and 20b.

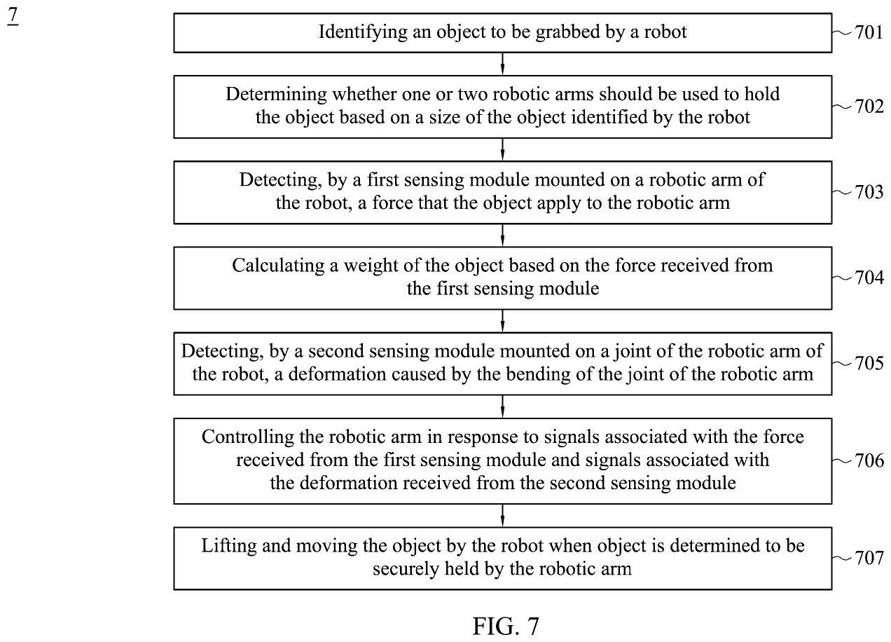

FIG. 7 is a flowchart showing a method 7 for controlling a robot, in accordance with some embodiments. The method 7 may be performed by a robot, such as a humanoid robot. In some embodiments, the method 7 may be executed by a processor of the robot (such as the processor 70). The method 7 includes operations 701, 702, 703, 704, 705, 706, and 707.

In operation 701, an object to be grabbed can be identified by the robot. In some embodiments, the robot can include sensors for identifying objects, such as optical sensors, infrared sensors, time of flight (ToF) sensors, or other suitable sensors.

In operation 702, whether one or two robotic arms should be used to hold the object can be determined based on a size of the object identified by the robot.

In operation 703, a force that the object apply to the robotic arm can be detect by a first sensing module (such as the sensing modules 20a of FIG. 6) mounted on a robotic arm of the robot. In some embodiments, a first signal can be detect by the first sensing module (such as the sensing modules 20a of FIG. 6) mounted on the robotic arm when the robotic arm holds the object, wherein the first signal is associated with the force that the object applies to the first sensing module (or the robotic arm). In some embodiments, the first sensing module may be located at an end of the robotic arm. The first sensing module may be in contact with the object when the robot is configured to grab the object.

In operation 704, a weight of the object can be calculated based on the force received from the first sensing module. In some embodiments, the weight of the object can be calculated based on the first signal.

In operation 705, a deformation caused by the bending of a joint of the robotic arm can be detected by a second sensing module (such as the sensing modules 20b of FIG. 6) mounted on the joint of the robotic arm of the robot. In some embodiments, a second signal can be detect by the second sensing module (such as the sensing modules 20b of FIG. 6) mounted on the joint of the robotic arm when the robotic arm holds the object, wherein the second signal is associated with the deformation of the second sensing module caused by the bending of the joint of the robotic arm. In some embodiments, the second sensing module may be free from contacting the object when the robot is configured to grab the object.

In operation 706, the robotic arm can be controlled in response to signals associated with the force received from the first sensing module and signals associated with the deformation received from the second sensing module. In some embodiments, the robotic arm can be controlled in response to the first signal of the first sensing module and the second signal of the second sensing module. In some embodiments, the robotic arm can be configured to grab the object in response to signals associated with the force received from the first sensing module. In some embodiments, the robotic arm can be configured to bend in response to signals associated with the force received from the second sensing module. In some embodiments, the robotic arm can determine whether the object is held securely based on the force received from the first sensing module and signals associated with the deformation received from the second sensing module.

In operation 707, the object can be lifted and moved by the robot when object is determined to be securely held by the robotic arm.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of embodiments of this disclosure are not deviated from by such an arrangement.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, a first numerical value can be deemed to be “substantially” the same or equal to a second numerical value if the first numerical value is within a range of variation of less than or equal to ±10% of the second numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” perpendicular can refer to a range of angular variation relative to 90° that is less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Two surfaces can be deemed to be coplanar or substantially coplanar if a displacement between the two surfaces is no greater than 5 μm, no greater than 2 μm, no greater than 1 μm, or no greater than 0.5 μm. A surface can be deemed to be substantially flat if a displacement between a highest point and a lowest point of the surface is no greater than 5 μm, no greater than 2 μm, no greater than 1 μm, or no greater than 0.5 μm.

As used herein, the singular terms “a,” “an,” and “the” may include plural referents unless the context clearly dictates otherwise.

As used herein, the terms “conductive,” “electrically conductive” and “electrical conductivity” refer to an ability to transport an electric current. Electrically conductive materials typically indicate those materials that exhibit little or no opposition to the flow of an electric current. One measure of electrical conductivity is Siemens per meter (S/m). Typically, an electrically conductive material is one having a conductivity greater than approximately 104 S/m, such as at least 105 S/m or at least 106 S/m. The electrical conductivity of a material can sometimes vary with temperature. Unless otherwise specified, the electrical conductivity of a material is measured at room temperature.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. An electronic device for detecting a robotic motion, comprising:
a 6-axis movable module; and
a plurality of sensing modules mounted on and protruding from an outer surface of the 6-axis movable module for detecting an amount of a rotation along at least one axis.

2. The electronic device of claim 1, wherein the plurality of sensing modules include a pressure sensor.

3. The electronic device of claim 1, wherein each of the plurality of sensing modules includes a piezoelectric element and an encapsulant covering the piezoelectric element, wherein the piezoelectric element is configured to detect a pressure applied to the 6-axis movable module.

4. The electronic device of claim 3, wherein the encapsulant is deformable.

5. The electronic device of claim 1, wherein a second number of the sensing modules are located at a joint connecting a first arm and a second arm of the 6-axis movable module, wherein the sensing module is configured to detect a deformation caused by a bending of the joint.

6. The electronic device of claim 1, wherein the sensing modules are configured to continuously detect a force applied to the sensing modules.

7. The electronic device of claim 1, further comprising processor electrically connected to the 6-axis movable module and the sensing modules.

8. The electronic device of claim 7, further comprising a signal processing circuit between the sensing modules and the processor, wherein the signal processing circuit includes one or more of a filter, an amplifier, a column or row decoder, or an A/D convertor.

9. The electronic device of claim 7, wherein the processor is configured to control a bending degree of the 6-axis movable module based on signals associated with the amount of the rotation along at least one axis.

10. An electronic device for detecting a robotic motion, comprising:
a robotic arm; and
a sensing module protruding from an outer surface of the robotic arm, wherein the sensing module includes an encapsulant configured to transmit a force applied on the sensing module.

11. The electronic device of claim 10, wherein the sensing module includes:
a frame encapsulated by the encapsulant, the frame defining a cavity; and
a piezoelectric element disposed within the cavity of the frame and encapsulated by the encapsulant.

12. The electronic device of claim 11, wherein the sensing module includes a film configured to detect the force applied to the sensing module.

13. The electronic device of claim 10, wherein the robotic arm includes a joint, and wherein the sensing module is arranged at the joint of the robotic arm.

14. The electronic device of claim 13, wherein the sensing module is configured to detect a bending degree of the joint of the robotic arm based on a deformation amount.

15. The electronic device of claim 10, wherein the encapsulant includes a conductive liquid silicone rubber (CLSR).

16. A method for controlling a robot, comprising:
identifying an object to be grabbed by the robot;
detecting, by a first sensing module mounted on a robotic arm of the robot, a first signal when the robotic arm holds the object;
detecting, by a second sensing module mounted on a joint of the robotic arm of the robot, a second signal when the robotic arm holds the object; and
controlling the robotic arm in response to the first signal and the second signal.

17. The method of claim 16, wherein the first signal is associated with a force that the object applies to the first sensing module, and the second signal is associated with a deformation of the second sensing module caused by the bending of the joint of the robotic arm.

18. The method of claim 16, further comprising calculating a weight of the object based on the first signal.

19. The method of claim 16, further comprising determining whether one or two robotic arms should be used to hold the object based on a size of the object identified by the robot.

20. The method of claim 16, wherein the controlling the robotic arm includes bending the robotic arm in response to the first signal and the second signal.
